(19) United States
(12) Patent Application Publication
(10) Pub. No.: US 2008/0123656 A1
(43) Pub. Date: May 29, 2008

(54) NETWORK DEVICE AND METHOD FOR SYNCHRONOUSLY TRANSMITTING DATA EMPLOYED BY THE SAME

(75) Inventors: CHING-HAO CHEN, Tu-Cheng (TW); HSI-HSUN HUANG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/945,273

(22) Filed: Nov. 27, 2007

(30) Foreign Application Priority Data
Nov. 29, 2006 (CN) 200610157129.9

(51) Int. Cl. H04L 12/56

(52) U.S. Cl. 370/394; 370/412

(57) ABSTRACT

A network device includes an active board and a standby board. The active board includes an active handler, an active queue processing module, and an active state machine module. The active handler is used for forwarding data. The active queue processing module is used for queuing the data via receiving sequence and forwarding via a preset rule. The standby board includes a standby queue transmitting module, a standby handler, a standby queue processing module, and a standby state machine module. The standby queue transmitting module is used for queuing the data via receiving sequence. The standby handler is used for forwarding the data to the standby queue processing module. The standby queue processing module is used for queuing the data via a receiving sequence. The standby state machine module is used for processing the data under the same state with the active state machine module.

### BACKGROUND OF THE INVENTION

1. Field of the Invention

The invention relates to network devices, and particularly to a network device with 1+1 redundancy architecture and method for synchronously transmitting data.

2. Description of Related Art

With development of electronic communication networks, more and more attention is paid to smooth uninterrupted operation of network devices in the electronic communication networks and loss of data. Conventionally, redundancy architecture is employed in the network devices to back-up data and provide recovery of functions.

In network devices a 1+1 redundancy architecture is often utilized, which includes an active board and a standby board. The active board and the standby board have the same architecture and function abilities. In a normal state, the active board executes the functions of the network device, and the standby board just backs up operation data. The active board transmits the operation data to the standby board for backing up via a main control processor (MCP). When the active board breaks down, the standby board takes over by employing the operation data backed up therein.

However, excessive data back up may overload the MCP, which results in data being lost. Once the active board breaks down, the network device cannot operate smoothly because the operation data of the active board and the standby board are not synchronized.

### SUMMARY OF THE INVENTION

An exemplary embodiment of the invention provides a network device for synchronously transmitting data. The network device employs redundancy architecture, including an active board and a standby board. The active board includes an active handler, an active queue processing module, and an active state machine module. The active handler is connected to the terminal device, and is used for receiving data sent by a terminal device, and forwarding the data. The active queue processing module is used for receiving the data forwarded by the active handler, queuing the data according to a receiving sequence, and forwarding the data based on a preset rule. The active state machine module is used for receiving the data forwarded by the active queue processing module, and processing the data. The standby board is connected to the terminal device and the active board, including a standby queue transmitting module, a standby handler, a standby queue processing module, and a standby state machine module. The standby queue transmitting module is used for receiving the data forwarded by the active handler, queuing the data according to receiving sequence, and forwarding the data according to a preset rule. The standby handler is used for receiving the data forwarded by the standby queue transmitting module, and forwarding the data. The standby queue processing module is used for receiving the data forwarded by the standby handler, queuing the data according to receiving sequence, and forwarding the data according a preset rule. The standby state machine module is used for receiving the data forwarded by the standby queue processing module, and processing the data under the same state as the active state machine module.

Another exemplary embodiment of the invention provides a method for synchronously transmitting data. The method includes providing an active board and a standby board, the active board includes an active handler, an active queue transmitting module, an active queue processing module, and an active state machine module, the standby board includes a standby queue transmitting module, a standby handler, a standby queue processing module, and a standby state machine module; the active handler receiving data; forwarding the data to the standby queue transmitting module and the active queue processing module; queuing the data via a receiving sequence and forwarding the data to the active state machine module via a preset rule; queuing the data via a receiving sequence and forwarding the queued data to the standby handler via a preset rule for forwarding to the standby queue processing module; queuing the data via a receiving sequence and forwarding the queued data to the standby state machine module via a preset rule; and processing the data under a same state.

Other advantages and novel features will become more apparent from the following detailed description when taken in conjunction with the accompanying drawings, in which:

### BRIEF DESCRIPTION OF THE DRAWINGS

FIG. 1 is a diagram of an application environment of a network device in accordance with an exemplary embodiment of the invention;

FIG. 2 shows a block diagram of a network device in accordance with another exemplary embodiment of the invention;

FIG. 3 shows a flow chart of a method for synchronously transmitting data in accordance with an exemplary embodiment of the invention; and

FIG. 4 shows a flow chart of a method for synchronously transmitting data in accordance with another exemplary embodiment of the invention.

### DETAILED DESCRIPTION OF THE INVENTION

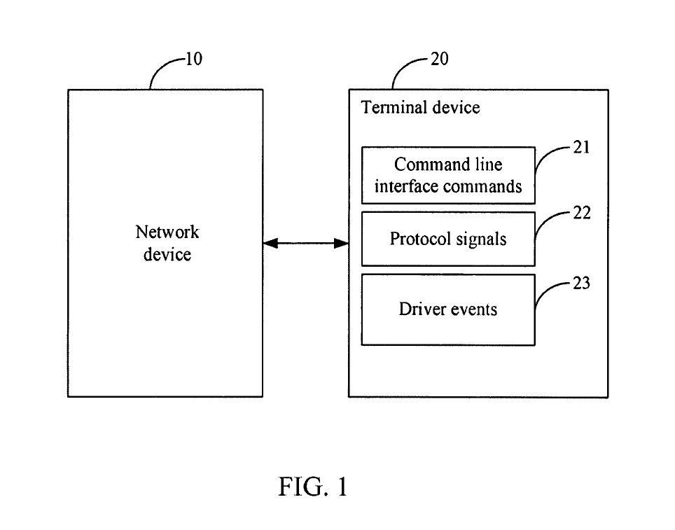

FIG. 1 is a diagram of an application environment of a network device 10 in accordance with an exemplary embodiment of the invention. In the exemplary embodiment, the network device 10 is connected to a terminal device 20, and is used for receiving and processing data sent by the terminal device 20. The data may include command line interface commands 21, protocol signals 22, and driver events 23. In the exemplary embodiment, the network device 10 is a gateway.

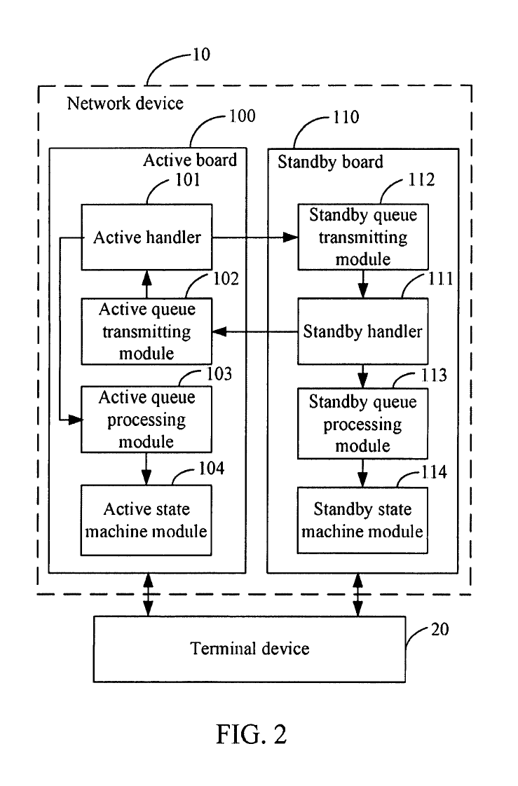

FIG. 2 shows a block diagram of the network device 10 in accordance with an exemplary embodiment of the invention. In the exemplary embodiment, the network device 10 includes an active board 100 and a standby board 110. The active board 100 is an operating board, and the standby board 110 is a backup board. The active board 100 is connected to the terminal device 20, and is used for receiving the data sent by the terminal device 20 and processing the data. The standby board 110 is connected to the terminal device 20 and the active board 100, and is used for receiving and storing data sent by the terminal device 20 and the active board 100, forwarding the data sent by the terminal device 20 to the active board 100, and processing the data sent by the terminal device 20 under a same state as the active board 100.

In the exemplary embodiment, the terminal device 20 only sends the protocol signals 22 to the standby board 110, and do not send the protocol signals 22 to the active board 100. However, the active board 100 and the standby board 110 can both process the protocol signals 22, and the protocol signals 22 must be processed with the command line interface commands 21 or the driver events 23 for generating a new signal. In the exemplary embodiment, the active board 100 and the standby board 110 both process the protocol signals 22 and the command line interface commands 21 together, or process the protocol signals 22 and the driver events 23 together. In the exemplary embodiment, the command line interface commands 21 include lockout commands, force switch commands, manual switch commands, and clear commands. The protocol signals 22 include lock out of protection signals, forced switch signals, signal fail high priority signals, signal fail low priority signals, signal degrade high priority signals, signal degrade low priority signals, manual switch signals, wait-to restore signals, reverse request signals, do not revert signals, and no request signals. The driver events 23 include loss of signal events, loss of frame events, alarm indicator signal events, and remote defect indication events.

In the exemplary embodiment, the active board 100 receives the command line interface commands 21 and the driver events 23 from the terminal device 20, and the standby board 110 receives the command line interface commands 21, the protocol signals 22, and the driver events 23.

The active board 100 includes an active handler 101, an active queue transmitting module 102, an active queue processing module 103, and an active state machine module 104.

The active handler 101 is connected to the terminal device 20, and is used for receiving the data from the terminal device 20, and forwarding the data to the standby board 110 and the active queue processing module 103. In the exemplary embodiment, the active handler 101 forwards the command line interface commands 21 and the driver events 23 sent by the terminal device 20 to the standby board 110 and the active queue processing module 103.

The active queue transmitting module 102 is connected to the active handler 101 and the standby board 110, and is used for receiving the data forwarded by the standby board 110 and forwarding the data to the active handler 101. In the embodiment, the active queue transmitting module 102 queues the data according to receiving sequence, and forwards the queued data to the active handler 101 according to a preset rule. In the embodiment, the preset rule is first in first out (FIFO). In the embodiment, the data forwarded by the standby board 110 includes the command line interface commands 21, the protocol signals 22, and the driver events 23. In another embodiment, the active queue transmitting module 102 is also receiving other data.

In the embodiment, the active handler 101 is further used for receiving the data forwarded by the active queue transmitting module 102, and for forwarding the data to the active queue processing module 103 and the standby board 110. In the embodiment, the data includes the command line interface commands 21, the protocol signals 22, and the driver events 23.

The active queue processing module 103 is connected to the active handler 101, and is used for receiving the data forwarded by the active handler 101, for queuing the data according to receiving sequence and forwarding the data via the preset rule same as that of the active queue transmitting module 102. In the embodiment, the active queue processing module 103 receives the command line interface commands 21, the protocol signals 22, and the driver events 23 forwarded by the active handler 101.

The active state machine module 104 is connected to the active queue processing module 103 and the terminal device 20, and is used for receiving the data forwarded by the active queue processing module 103 and processing. In the embodiment, if the data includes the protocol signals 22, the active state machine module 104 processes the protocol signals 22 with the command line interface commands 21, or processes the protocol signals 22 with the driver events 23, or processes the protocol signals 22 with the command line interface commands 21 and the driver events 23. In the embodiment, the active state machine module 104 is further used for generating a synchronization switch control signal for switching states of the active board 100, and then the active board 100 sends the switched state to the terminal device 20 for maintaining communication with the terminal device 20.

The standby board 110 includes a standby handler 111, a standby queue transmitting module 112, a standby queue processing module 113, and a standby state machine module 114.

The standby handler 111 is connected to the terminal device 20 and the active queue transmitting module 102, and is used for receiving data sent by terminal device 20, and for forwarding the data to the active queue transmitting module 102. In the embodiment, the data includes the command line interface commands 21, the protocol signals 22, and the driver events 23.

The standby queue transmitting module 112 is connected to the standby handler 111 and the active handler 101, and is used for receiving the data forwarded by the active handler 101 and for forwarding the data to the standby handler 111. In the embodiment, the standby queue transmitting module 112 queues the data according to receiving sequence, and forwards the data to the standby handler 111 according to a preset rule same as that of the active queue transmitting module 102.

In another embodiment, the standby queue transmitting module 112 also receives other data.

In the embodiment, the standby handler 111 is further used for receiving the data forwarded by the standby queue transmitting module 112.

The standby queue processing module 113 is connected to the standby handler 111, and is used for receiving the data forwarded by the standby hander 111, and queuing the data according to receiving sequence, and forwarding the data according to a preset rule same as that of the active queue transmitting module 102. In the embodiment, the data includes the command line interface commands 21, the protocol signals 22, and the driver events 23.

The standby state machine module 114 is connected to the standby queue processing module 113 and terminal device 20, and is used for receiving the data forwarded by the standby queue processing module 113 and for processing the data under the same state as the active state machine module 104. In the embodiment, if the data includes the protocol signals 22, the standby state machine module 114 processes the protocol signals 22 with the command line interface commands 21, or processes the protocol signals 22 with the driver events 23, or processes the protocol signals 22 with command line interface commands 21 and the driver events 23. In the embodiment, the standby state machine module 114 is further used for generating a synchronization switch control signal for switching the backup state of the standby board 110 and a new protocol signal, then, the standby board 110 sends the switched state and the new protocol signal to the terminal device 20 for maintaining communication with the terminal device 20.

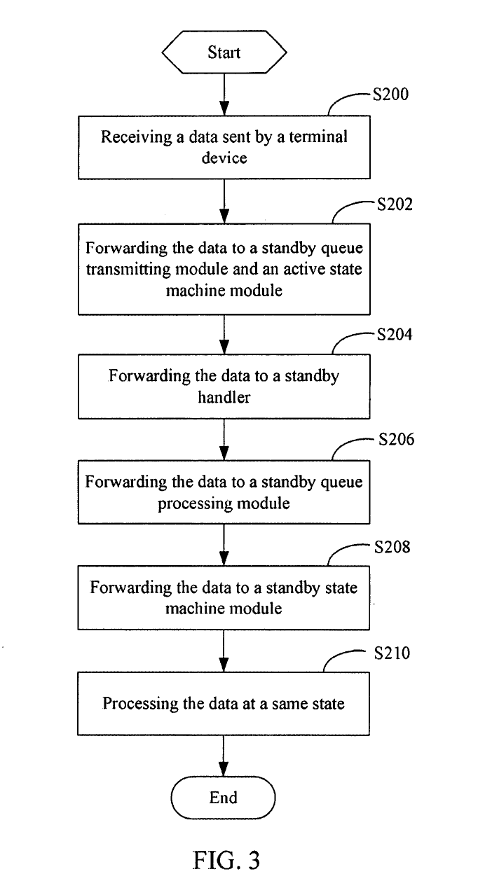

FIG. 3 shows a flow chart of a method for synchronously transmitting data in accordance with an exemplary embodiment of the invention. In the embodiment, the active board 100 receives data sent by the terminal device 20, and forwards the data to the standby board 110 after the active board 100 processes the data sent by the terminal device 20.

In step S200, the active handler 101 receives the data sent by the terminal device 20. In the embodiment, the active handler 101 receives the command line interface commands 21 and the driver events 23 sent by the terminal device 20.

In step S202, the active handler 101 forwards the data to the standby queue transmitting module 112, and forwards the data to the active state machine module 104 via the active queue processing module 103. In the embodiment, the active queue processing module 103 receives the data forwarded by the active handler 101, queues the data according to receiving sequence, and forwards the queued data to the active state machine module 104 according to a preset rule. In the embodiment, the preset rule is first in first out (FIFO).

In step S204, the standby queue transmitting module 112 forwards the data to the standby handler 111. In the embodiment, the standby queue transmitting module 112 queues the data according to receiving sequence and forwards the queued data to the standby handler 111 according to a preset rule same as that of the active queue processing module 103.

In step S206, the standby handler 111 forwards the data to the standby queue processing module 113.

In step S208, the standby queue processing module 113 forwards the data to the standby state machine module 114. In the embodiment, the standby queue processing module 113 receives the data forwarded by the standby handler 111, queues the data according to receiving sequence, and forwards the queued data to the standby state machine module 114 according to a preset rule same as that of the active queue processing module 103.

In step S210, the active state machine module 104 and the standby state machine module 114 both process the data under a same state. In the embodiment, the active state machine module 104 generates a synchronization switch control signal for switching the working state of the active board 100, and the active board 100 sends the switched state to the terminal device 20. The standby state machine module 114 generates a synchronization switch control signal for switching the backup state of the standby board 110 and a new protocol signal, and the standby board 110 sends the switched state and the new protocol signal to the terminal device 20.

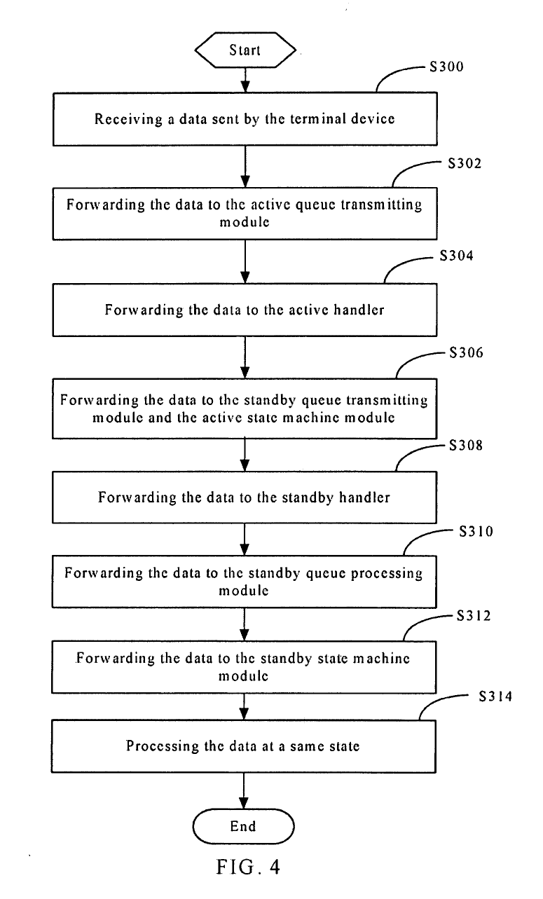

FIG. 4 shows a flow chart of a method for synchronously transmitting data in accordance with another exemplary embodiment of the invention. In the embodiment, the standby board 110 receives data sent by the terminal device 20, forwards the data to the active board 100, and then receives the data from the active board 100.

In step S300, the standby handler 111 receives the data. In the embodiment, the data include the command line interface commands 21, the protocol signals 22, and the driver events 23.

In step S302, the standby handler 111 forwards the data to the active queue transmitting module 102.

In step S304, the active queue transmitting module 102 forwards the data to the active handler 101. In the embodiment, the active queue transmitting module 102 queues the data according to receiving sequence, and forwards the queued data to the active handler 101 according to a preset rule. In the embodiment, the preset rule is first in first out (FIFO). In the embodiment, the data includes the command line interface commands 21, the protocol signals 22, and the driver events 23. In another embodiment, the active queue transmitting module 102 also receives other data.

In step S306, the active handler 101 forwards the data to the standby queue transmitting module 112, and forwards the data to the active state machine module 104 via the active queue processing module 103. In the embodiment, the active processing module 103 receives the data, queues the data according to receiving sequence, and forwards the queued data to the active state machine module 114 according to a preset rule same as that of the active queue transmitting module 102.

In step S308, the standby queue transmitting module 112 forwards the data to the standby handler 111. In the embodiment, the standby queue transmitting module 112 queues the data according to receiving sequence, and forwards the queued data to the standby handler 111 according to a preset rule same as that of the active queue transmitting module 102. In the embodiment, the data includes the command line interface commands 21, the protocol signals 22, and the driver events 23. In another embodiment, the standby queue transmitting module 112 also receives other data.

In step S310, the standby handler 111 forwards the data to the standby queue processing module 113.

In step S312, the standby queue processing module 113 forwards the data to the standby state machine module 114. In the embodiment, the standby queue processing module 113 receives the data forwarded by the standby handler 111, queues the data according to receiving sequence, and forwards the queued data to the active state machine module 114 according to a preset rule same as that of the active queue transmitting module 102.

In step S314, the active state machine module 104 and the standby state machine module 114 process the data under a same state. In the embodiment, the active state machine module 104 generates a synchronization switch control signal for switching the working state of the active board 100, and then the active board 100 sends the switched state to the terminal device 20. The standby state machine module 114 generates a synchronization switch control signal for switching the backup state of the standby board 110 and a new protocol signal, and then the standby board 110 sends the switched state and the new protocol signal to the terminal device 20.

In another embodiment, the active handler 101 and the standby handler 111 also receive the data sent by the terminal device 20 under the same time, the method for synchronously transmitting data of FIG. 2 and FIG. 3 could be processed under the same time.

The network device 10 and the method for synchronously transmitting data make that the active board 100 and the standby board 110 transmit data according to a same queue and preset rule, and process the data under a same state for synchronously transmitting data. Therefore, the network device 10 and the method for synchronously transmitting data decrease a risk of losing data and the burden of having a main control processor.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments.

What is claimed is:

1. A network device employing a redundancy architecture, the network device comprising:
an active board, comprising:
an active handler connected to the terminal device, for receiving data sent by a terminal device, and forwarding the data;
an active queue processing module for receiving the data forwarded by the active handler, queuing the data according to a receiving sequence, and forwarding the data based on a preset rule; and
an active state machine module for receiving the data forwarded by the active queue processing module, and processing the data; and
a standby board connected to the terminal device and the active board, comprising:
a standby queue transmitting module for receiving the data forwarded by the active handler, queuing the data according to receiving sequence, and forwarding the data according to a preset rule;
a standby handler for receiving the data forwarded by the standby queue transmitting module, and forwarding the data;
a standby queue processing module for receiving the data forwarded by the standby handler, queuing the data according to receiving sequence, and forwarding the data according to a preset rule; and
a standby state machine module for receiving the data forwarded by the standby queue processing module, and processing the data under a same state with the active state machine module.

2. The network device of claim 1, wherein the standby handler is further used for receiving the data sent by the terminal device, and forwarding the data.

3. The network device of claim 2, wherein the active board further comprises:
an active queue transmitting module connected to the active handler and the standby handler, for receiving the data forwarded by the standby handler, queuing the data according to receiving sequence, and forwarding the data to the active handler according to a preset rule same as that of the standby queue transmitting module.

4. The network device of claim 3, wherein the active handler is further used for receiving the data forwarded by the active queue transmitting module.

5. The network device of claim 1, wherein the active state machine module is further used for generating a synchronization switch signal, for switching states of the active board, and the active board is further used for sending the switched states to the terminal device.

6. The network device of claim 1, wherein the standby state machine module is further used for generating a synchronization switch signal for switching a backup state of the standby board and a new protocol signal, the standby board is further used for sending the switched state and the new protocol signal to the terminal device.

7. The network device of claim 1, wherein the preset rule is first in first out (FIFO).

8. A method for synchronously transmitting data, comprising:
providing an active board and a standby board, the active board comprising an active handler, an active queue transmitting module, an active queue processing module, and an active state machine module, the standby board comprising a standby queue transmitting module, a standby handler, a standby queue processing module, and a standby state machine module;
the active handler receiving data;
forwarding the data to the standby queue transmitting module and the active queue processing module;
queuing the data according to receiving sequence and forwarding the data to the active state machine module according to a preset rule;
queuing the data according to receiving sequence and forwarding the queued data to the standby handler according to a preset rule for forwarding to the standby queue processing module;
queuing the data according to receiving sequence and forwarding the queued data to the standby state machine module according to a preset rule; and
processing the data under a same state.

9. The method for synchronously transmitting data of claim 8, wherein the preset rule is first in first out (FIFO).

10. The method for synchronously transmitting data of claim 8, wherein the step of the active handler receiving data further comprises steps of:
the standby handler receiving data forwarded by the terminal device;
forwarding the data to the active queue transmitting module; and
queuing the data according to receiving sequence and forwarding the queued data to the active handler according to a preset rule.

11. The method for synchronously transmitting data of claim 8, wherein the step of the active handler receiving data further comprises:
the active handler receiving the data forwarded by a terminal device.

12. The method for synchronously transmitting data of claim 8, wherein processing the data under a same state further comprises:
the active state machine module receiving the data and processing; and
the standby state machine module receiving the data, and processing the data under the same state with the active state machine module.

13. The method for synchronously transmitting data of claim 12, wherein the step of the active state machine module receiving the data and processing further comprises:
generating a synchronization switch signal;
switching a working state of the active board; and
sending the switched state to a terminal device.

14. The method for synchronously transmitting data of claim 12, wherein the step of the standby state machine module receiving the data, and processing the data under the same state the active state machine module further comprises:
generating a synchronization switch signal and a new protocol signal;
switching a backup state of the standby board; and
sending the switched state and the new signal to a terminal device.

15. A method for synchronously transmitting data between an active board which is an operating board for data transmission and a standby board which is a backup board for said active board, comprising:
setting an active handler in said active board;
setting a standby handler in said standby board;
receiving data firstly by one of said active handler and said standby handler;
forwarding said data to said active handler by queuing said data when said standby handler firstly receives said data;
queuing said data according to receiving sequence and forwarding said queued data to an active state machine module of said active board according to a preset rule;
forwarding said data to said standby handler by queuing said data according to receiving sequence;
queuing said data according to receiving sequence and forwarding said queued data to a standby state machine module of said standby board according to said preset rule; and
processing said data under a same state in said active state machine module of said active board and in said standby state machine module of said standby board respectively.

16. The method of claim 15, wherein said preset rule is first in first out (FIFO).
